(19) United States
(12) Patent Application Publication
(10) Pub. No.: US 2025/0361925 A1
(43) Pub. Date: Nov. 27, 2025

(54) ELECTRIC DRIVE SYSTEM FOR A MOTOR VEHICLE

(71) Applicant: MERCEDES-BENZ GROUP AG, Stuttgart (DE)

(72) Inventors: Peter APPELTAUER, Fellbach (DE); Andreas KOLB, Wernau (DE); Tobias HAERTER, Stuttgart (DE); Peter HAHN, Stuttgart (DE)

(21) Appl. No.: 18/837,361

(22) PCT Filed: Feb. 3, 2023
(86) PCT No.: PCT/EP2023/052672

§ 371 Date: Jan. 27, 2025

(30) Foreign Application Priority Data
Feb. 10, 2022 (DE) 10 2022 000 515.8

(51) Int. Cl. F16H 3/74; B60K 1/02

(52) U.S. Cl. CPC F16H 3/74; B60K 1/02

(57) ABSTRACT

The invention relates to an electric drive system (10) for a motor vehicle, having a first electric engine (16) with a first rotor (20), a second electric engine (24) with a second rotor (28), and a planetary gearbox (30), which has a first planetary gear set (32), a second planetary gear set (32), a first input shaft (36), a second input shaft (38), a first output shaft (40) and a second output shaft (42), wherein the first input shaft (36) is formed to introduce first torques, emanating from the first electric engine (16), into the planetary gearbox (30), the second input shaft (38) is formed to introduce second torques, emanating from the second electric engine (24), into the planetary gearbox (30), the first output shaft (40) is formed to discharge third torques from the planetary gearbox (30), and the second output shaft (42) is formed to discharge fourth torques from the planetary gearbox (30).

The invention relates to an electric drive system for a motor vehicle according to the preamble of claim 1.

A drive engine for driving two rotating shafts is taken as known from US 2015/0065282 A1.

The object of the present invention is to create an electric drive system for a motor vehicle, so that particularly good driveability and particularly compact installation can be implemented.

This object is solved by an electric drive system having the features of claim 1. Advantageous embodiments with expedient developments of the invention are specified in the remaining claims.

The invention relates to an electric drive system, also referred to as an electric drive device or formed as an electric drive device, for a motor vehicle, in particular for a motor car. This means that, in its completely produced state, the motor vehicle has the electric drive system and can be driven electrically, in particular purely electrically, by means of the electric drive system. In particular, in its completely produced state, the motor vehicle has, for example, at least or exactly two axles, which are arranged in succession in the vehicle longitudinal direction and thus one behind the other. The respective axle has, for example, at least or exactly two wheels, also referred to as vehicle wheels, wherein preferably the wheels of the respective axle are arranged on the opposite side of the motor vehicle to each other in the vehicle transverse direction. The wheels are ground contact elements, by which the motor vehicle is or can be supported downwards on the ground, in the vertical direction of the vehicle. For example, the electric drive system is assigned to at least one of the axles or exactly one of the axles, so that, for example, the wheels of at least or exactly one of the axles can be driven by means of the electric drive system. The wheels driven by means of the electric drive system are also referred to as drive wheels. If the drive wheels and thus the motor vehicle are driven by means of the electric drive system while the motor vehicle is supported downwards by the wheels on the ground in the vertical direction of the vehicle, the motor vehicle is driven along the ground and the wheels roll on the ground.

The electric drive system has a first electric engine having a first rotor. For example, the first electric engine has a first stator, by means of which the first rotor can be driven and therefore can be rotated around a first engine rotational axis, relative to the first stator. Furthermore, the electric drive system has a second electric engine which has a second rotor. For example, the second electric engine has a second stator, by means of which the second rotor can be driven and therefore can be rotated around a second engine rotational axis, relative to the second stator. Furthermore, the drive system has at least or exactly one planetary gearbox, which has a first planetary gear set, a second planetary gear set, a first input shaft, a second input shaft, a first output shaft and a second output shaft. The first input shaft is formed to introduce first torques, emanating from the first electric engine, in particular from the first rotor, into the planetary gearbox. In particular, this can be understood to mean that the first electric engine, in particular via its first rotor, can supply the first torques, which can be introduced into the planetary gearbox via the first input shaft. This can be used to drive the planetary gearbox in particular. The second input shaft is formed to introduce second torques, emanating from the second electric engine, in particular from the second rotor, into the planetary gearbox. In particular, this can be understood to mean that the second electric engine, in particular via its second rotor, can supply the second torques, which can be introduced into the planetary gearbox via the second input shaft, in particular bypassing the first input shaft. This can be used to drive the planetary gearbox for example. Furthermore, it is conceivable that the first torques can be introduced into the planetary gearbox via the first input shaft, bypassing the second input shaft. This can be understood to mean the following in particular: The first torques, that can be or are provided by the first electric engine, in particular by the first rotor, do not run or flow, for example, on their way from the first electric engine, in particular from the first rotor, into the planetary gearbox, via the second input shaft, i.e. the first torques bypass the second input shaft, so that, for example, the second input shaft is not arranged in the first torque transmission path or at least not in the first torque transmission path between the first electric engine and the planetary gearbox, relative to a first torque transmission path by which the first torques, provided by the first electric engine, in particular by the first rotor, can be transmitted from the first electric engine, in particular from the first rotor, onto the first input shaft and can be introduced via the first input shaft into the planetary gearbox. The same applies to the second electric engine and the second torques. The second torques, that can be or are provided by the second electric engine, in particular by the second rotor, do not run or flow, for example, on their way from the second electric engine, in particular from the second rotor, into the planetary gearbox, via the first input shaft, i.e. the second torques bypass the first input shaft, so that, for example, the first input shaft is not arranged in the second torque transmission path or at least not in the second torque transmission path between the second electric engine and the planetary gearbox, relative to a second torque transmission path, by which the second torques, provided by the second electric engine, in particular by the second rotor, can be transmitted from the second electric engine, in particular from the second rotor, onto the second input shaft and can be introduced via the second input shaft into the planetary gearbox.

The first output shaft is formed to discharge third torques from the planetary gearbox. For example, the third torques result from the first torques, introduced into the planetary gearbox, and/or from the second torques, introduced into the planetary gearbox. The second output shaft is formed to discharge fourth torques from the planetary gearbox, in particular bypassing the first output shaft, wherein, for example, the fourth torques result from the first torques, introduced into the planetary gearbox, and/or from the second torques, introduced into the planetary gearbox. In particular, it is conceivable that the first output shaft is formed to discharge the third torques from the planetary gearbox, bypassing the second output shaft.

The first planetary gear set has a first element, which can be connected in a rotationally fixed manner to the first rotor, a second element, connected, in particular permanently, in a rotationally fixed manner to the first output shaft, and a third element, connected, in particular permanently, in a rotationally fixed manner to the second output shaft. The first element, the second element and the third element are first gear elements of the first planetary gear set or are also referred to as first gear elements. The second planetary gear set has a fourth element, which can be connected in a rotationally fixed manner to the second rotor, and a fifth element, connected, in particular permanently, in a rotationally fixed manner to the second element.

In order to realise particularly advantageous driveability and particularly compact installation, it is provided according to the invention that the second planetary gear set also has a sixth element, connected, in particular permanently, in a rotationally fixed manner to the third element. The fourth element, the fifth element and the sixth element are second gear elements of the second planetary gear set or are also referred to as second gear elements.

Furthermore, it is provided according to the invention that the electric drive system has a third planetary gear set. Preferably, the electric drive system has exactly three planetary gear sets, specifically the first planetary gear set, the second planetary gear set and the third planetary gear set. The third planetary gear set has a seventh element, which is or can be connected in a rotationally fixed manner to the first element, an eighth element, which can be connected in a rotationally fixed manner to the first rotor or the second rotor, and a ninth element, which is or can be connected in a rotationally fixed manner to the fourth element. The seventh element, the eighth element and the ninth element are third gear elements of the third planetary gear set or are also referred to as third gear elements.

In particular, it is conceivable that one of the first gear elements is a sun gear, another of the first gear elements is an annular gear and yet another of the first gear elements is a planetary carrier, also referred to as a bridge. Furthermore, it is conceivable that one of the second gear elements is a sun gear, another of the second gear elements is an annular gear and yet another of the second gear elements is a planetary carrier, also referred to as a bridge. Furthermore, it is conceivable that one of the third gear elements is a sun gear, another of the third gear elements is an annular gear and yet another of the third gear elements is a planetary carrier, also referred to as a bridge.

In the scope of the present disclosure, ordinal numbers, also referred to as ordinals, such as for example “first,” “second” etc. are not necessarily used to specify or imply a number or amount, but to be able to clearly reference terms which are assigned the ordinal numbers or to which the ordinal numbers refer. Therefore, the following may be provided in particular: The first planetary gear set has, for example, a first sun gear, a first planetary carrier, also referred to as a first bridge, and a first annular gear. The first sun gear, the first planetary carrier and the first annular gear are, for example, the first gear elements of the first planetary gear set. The second planetary gear set has, for example, a second sun gear, a second planetary carrier, which is also referred to as a second bridge, and a second annular gear. The second sun gear, the second planetary carrier and the second annular gear are the second gear elements. For example, the third planetary gear set has a third sun gear, a third planetary carrier, also referred to as a third bridge, and a third annular gear. The third sun gear, the third planetary carrier and the third annular gear are the third gear elements. A first of the first gear elements is also referred to as a first element or is the aforementioned first element, a second of the first gear elements of the first planetary gear set is also referred to as a second element or is the aforementioned second element, and a third of the first gear elements of the first planetary gear set is also referred to as a third element or is the aforementioned third element. A first of the second gear elements of the second planetary gear set is also referred to as a fourth element or is the aforementioned fourth element, a second of the second gear elements of the second planetary gear set is also referred to as a fifth element or is the aforementioned fifth element, and a third of the second gear elements of the second planetary gear set is also referred to as a sixth element or is the aforementioned sixth element. A first of the third gear elements of the third planetary gear set is also referred to as a seventh element or is the aforementioned seventh element, a second of the third gear elements of the third planetary gear set is also referred to as an eighth element or is the aforementioned eighth element, and a third of the third gear elements of the third planetary gear set is also referred to as a ninth element or is the aforementioned ninth element.

In the context of the present disclosure, the feature that two components such as the third element and the sixth element are connected in a rotationally fixed manner to one another is to be understood as meaning that the two components are arranged coaxially to one another and are connected to one another in such a way that they rotate, in particular about a common component axis of rotation and/or relative to a housing element of the drive system, at the same angular velocity, in particular when the components or one of the components and, in particular, the other component are or is driven via the one component. In other words, in the context of the present disclosure, the term or expression a rotationally fixed connection of two rotatably mounted components means that the two components are arranged coaxially to one another and are connected to one another in such a way that they rotate at the same angular velocity. Furthermore, in the context of the present disclosure, the feature that two components are permanently connected in a rotationally fixed manner to one another is to be understood to mean that these components are not assigned a switching element which can be switched between a coupled state, in which the components are connected in a rotationally fixed manner to one another, and a decoupled state, in which the switching element permits a relative rotation between the components, in particular about the aforementioned component rotational axis, but rather the components are always or at all times, i.e. permanently, connected in a rotationally fixed manner to one another. Furthermore, in the context of the present disclosure, the feature that two components, such as the second rotor and the fourth element, can be connected to one another in a rotationally fixed manner means that these components are assigned a switching element which can be switched between a coupled state and a decoupled state. In the coupled state, the components are connected to each other in a rotationally fixed manner by means of the switching element assigned to the components. In the decoupled state, the switching element assigned to the components allows a relative rotation to take place, in particular around the aforementioned component rotational axis, between the components to which the switching element is assigned.

Preferably, the second gear elements are provided in addition to the first gear elements. Furthermore, preferably, the third gear elements are provided in addition to the second gear elements and to the first gear elements. In particular, when the respective, first gear element is not connected in a rotationally fixed manner to a housing device, such as the aforementioned housing element of the drive system, for example, the respective first gear element can be rotated around a first planetary gear set rotational axis of the first planetary gear set, relative to the housing device, which is the aforementioned housing element, for example. Correspondingly, the respective second gear element, for example, can in particular then be rotated around a second planetary gear set rotational axis of the second planetary gear set, relative to the housing device, when the respective second gear element is not connected in a rotationally fixed manner to the housing device. Correspondingly, the respective third gear element, for example, can in particular be rotated around a third planetary gear set rotational axis of the third planetary gear set, relative to the housing device, when the respective third gear element is not connected in a rotationally fixed manner to the housing device. It is conceivable that at least or exactly two of the planetary gear sets or the three planetary gear sets are arranged coaxially to each other, so that at least or exactly two of the planetary gear set rotational axes or all three of the planetary gear set rotational axes coincide.

In order to be able to realise a particularly compact and thus installation space-favourable design of the electric drive system, it is provided in an embodiment of the invention that a first stationary transmission ratio of the first planetary gear set has the same absolute value and an opposing sign in comparison to a second stationary transmission ratio of the second planetary gear set. In other words, the first planetary gear set has a first stationary transmission ratio, and the second planetary gear set has a second stationary transmission ratio. The stationary transmission ratios of the planetary gear sets have the same value, i.e. the same absolute value, wherein the stationary transmission ratios of the planetary gear sets have different mathematical signs, however. Thus, for example, one of the stationary transmission ratios has a positive mathematical sign (+) and the other stationary transmission ratio has a negative mathematical sign (−).

It has proven to be particularly advantageous for realising a particularly compact design when the first stationary transmission ratio has a value of −2, i.e. is −2. Furthermore, it has proven to be particularly advantageous when the second stationary transmission ratio has a value of +2, i.e. is +2. In this case, it is very preferably provided that a third stationary transmission ratio of the third planetary gear set has a value of at least substantially 5/3, i.e. is 5/3 or 1⅔ or 1.667.

A further embodiment is characterised in that the second element of the first planetary gear is the first planetary carrier, which is preferably formed as a single planetary carrier having first planetary gears. This is understood in particular to mean that the first planetary gears are rotatably mounted on the first planetary carrier, in particular in such a way that the respective first planetary gear can be rotated around a respective first planetary gear rotational axis, relative to the first planetary carrier. Therefore, it is in particular provided that the first planetary gear rotational axes run parallel to each other and are spaced apart from each other. In particular, the first planetary gear rotational axes are evenly spaced apart in pairs in the first circumferential direction of the first planetary gear set, extending in particular around the first planetary gear set axis of rotation. In this case it is preferably provided that the first planetary gears are constructed identically to each other and are arranged in particular in the axial direction of the first planetary gear set at the same height, and thus begin at the same first height and end at the same second height, in particular in the axial direction of the first planetary gear set.

In this case, it has proven to be particularly advantageous when the fifth element of the second planetary gear set is the second planetary carrier, which is very preferably formed as a double planetary carrier having second planetary gears and third planetary gears. This is understood to mean in particular that the second planetary gears and the third planetary gears are rotatably mounted on the second planetary carrier, in particular in such a way that the respective second planetary gear can be rotated around a respective second planetary gear rotational axis relative to the second planetary carrier, and that the respective third planetary gear can be rotated around a respective third planetary gear rotational axis relative to the second planetary carrier. In this case, it is in particular conceivable that the second planetary gear rotational axes run parallel to each other and are spaced apart from each other.

Furthermore, it is conceivable that the third planetary gear rotational axes run parallel to each other and are spaced apart from each other, in particular in a second circumferential direction of the second planetary gear set.

Preferably, the second planetary gears are of identical construction. Furthermore, preferably, the third planetary gears are of identical construction. For example, the third planetary gear rotational axes run parallel to the second planetary gear rotational axes.

Thus, for example, the second planetary gears are arranged in the axial direction of the second planetary gear set at the same height, i.e. the second planetary gears begin and end at the respective same height when viewed in the axial direction of the second planetary gear set. Alternatively, or additionally, for example, the third planetary gears are arranged in the axial direction of the second planetary gear set at the same height, so that preferably the third planetary gears begin and end at the respective same height when viewed in the axial direction of the planetary gear set.

In this case, it is conceivable in particular that the respective second planetary gear and the respective third planetary gear differ from each other in regard to their construction.

Furthermore, it is conceivable that the respective second planetary gear and the respective third planetary gear, when viewed in the axial direction of the planetary gear set, are arranged at the same or different heights, i.e. begin at the same height or at another height and/or end at the same or at another height. Furthermore, it is preferably provided that the first planetary gears are formed to be separate from the second planetary gears and to be separate from the third planetary gears. Furthermore, it is conceivable that the second planetary gears are formed to be separate from the third planetary gears.

Preferably, the second planetary gears are engaged with the second sun gear, wherein the respective second planetary gear is engaged with one of the third planetary gears and not with the second annular gear. Preferably, the third planetary gears are engaged with the second annular gear, wherein the respective third planetary gear is engaged with one of the second planetary gears and not with the second sun gear.

In order to achieve a particularly compact design, it is provided in a further embodiment of the invention that the third element and the sixth element have the same toothing diameters, in particular the same pitch circle diameters, and the same number of teeth. The respective number of teeth is to be understood as a respective number of respective teeth of a respective toothing of the third or sixth element.

A further, particularly advantageous embodiment is characterised in that the eighth element is formed as a sum shaft of the third planetary gear set.

In order to be able to provide particularly advantageous driveability in a particularly space-saving manner, it is provided in a further embodiment of the invention that the electric drive system has a first switching element which is formed to connect the first rotor in a rotationally fixed manner to the eighth element. This means in particular that the first switching element can be switched between a first coupled state and a first decoupled state. In the first coupled state, the first rotor and the eighth element are connected in a rotationally fixed manner to each other by means of the first switching element, so that the first rotor and the eighth element rotate or can rotate together or simultaneously, i.e. at the same angular velocity, in particular around the third planetary gear set rotational axis and/or relative to the housing element, in particular when the planetary gear is driven. In the first decoupled state, the first switching element allows relative rotations between the first rotor and the eighth element, in particular around the third planetary gear set rotational axis. For example, the first switching element can be moved, in particular translationally and/or relative to the housing element, between at least one first coupled position, which brings about the first coupled state, and at least one first decoupled position, which brings about the first decoupled state.

It has also proven to be particularly advantageous if the electric drive system has a second switching element which is formed to connect the first rotor in a rotationally fixed manner to the first element. This means in particular that the second switching element can be switched between a second coupled state and a second decoupled state. In the second coupled state, the first rotor and the first element are connected in a rotationally fixed manner to each other by means of the second switching element, so that the first rotor and the first element rotate or can rotate together or at the same angular velocity, in particular around the first planetary gear set rotational axis or around the second engine rotational axis and/or around the housing element, in particular when the planetary gearbox is being driven. In the second decoupled state, the second switching element allows relative rotations to take place between the first rotor and the first element, in particular around the first planetary gear set rotational axis or around the second engine rotational axis. For example, the second switching element can be moved, in particular relative to the housing element and/or translationally, between at least one second coupled position, which brings about the second coupled state, and at least one second decoupled position, which brings about the second decoupled state.

Furthermore, a third switching element is preferably provided, which is formed to connect the second rotor in a rotationally fixed manner to the fourth element. This means in particular that the third switching element can be switched between a third coupled state and a third decoupled state. In the third coupled state, the second rotor and the fourth element are connected in a rotationally fixed manner to each other by means of the third switching element, so that the second rotor and the third element rotate or can rotate together or at the same angular velocity, in particular around the first engine rotational axis or around the second planetary gear set rotational axis and/or relative to the housing element, in particular when the planetary gearbox is being driven. In the third decoupled state, the third switching element allows relative rotations to take place between the second rotor and the fourth element, in particular around the first engine rotational axis or around the second planetary gear set rotational axis. For example, the third switching element can be moved, in particular relative to the housing element and/or translationally, between at least one third coupled position, which brings about the third coupled state, and at least one third decoupled position, which brings about the third decoupled state.

In order to be able to provide particularly advantageous driveability in a particularly space-saving manner, it is provided in a further embodiment of the invention that the first element is the first sun gear, i.e. that the first element is formed as the first sun gear. Furthermore, it is preferably provided that the fourth element is formed as the second sun gear, i.e. is the second sun gear, that the third element is the first annular gear, i.e. is formed as the first annular gear, and that the sixth element is formed as the second annular gear, i.e. is the second annular gear.

In a further, particularly advantageous embodiment of the invention, the electric drive system has a blocking switching element, which is formed to connect two elements of the first planetary gear set and of the second planetary gear set, which are not permanently connected to each other in a rotationally fixed manner, to each other in a rotationally fixed manner. In other words, one of the elements is also referred to as a first blocking element and another of the elements is also referred to as a second blocking element. For example, the first blocking element is one of the elements of the first planetary gear set. For example, the second blocking element is one of the elements of the second planetary gear set. Furthermore, it is conceivable that the blocking elements are two of the elements of the same planetary gear set, i.e. of the first or second planetary gear set, for example. Thus, the blocking switching element is assigned to the blocking elements, and the blocking elements are not connected permanently in a rotationally fixed manner to each other. The blocking switching element can, for example, be switched between a fourth coupled state and a fourth decoupled state. In the fourth coupled state, the blocking elements, to which the blocking switching element is assigned, are connected to each other in a rotationally fixed manner by means of the blocking switching element. In the fourth decoupled state, the blocking switching element allows relative rotations to take place between the blocking elements to which the blocking switching element is assigned, in particular around the first and/or second planetary gear set rotational axis. In particular, the blocking switching element can be provided in addition to the first switching element, in addition to the second switching element and in addition to the third switching element. If the blocking elements, to which the blocking element is assigned, are connected to each other in a rotationally fixed manner by means of the blocking switching element and thus interlocked with each other, the or all of the first gear elements and the or all of the second gear elements revolve as a block and thus together or simultaneously, in particular when the planetary gearbox is being driven. In particular, when the planetary gearbox is formed as a differential, formed as a planetary differential gearbox, the blocking switching element can be used as a differential lock, which is activated or engaged in particular when the blocking switching element is located in its fourth blocked state, whereby the differential lock is then deactivated in particular and thus disengaged when the blocking switching element is located in its fourth decoupled state.

Finally, it has proven to be particularly advantageous when the three planetary gear sets and the two rotors are all arranged coaxially to each other, so that the planetary gear set rotational axes coincide, the engine rotational axes coincide, and the engine rotational axes coincide with the planetary gear set rotational axes. As a result, a particularly space-saving design can be achieved.

In a further, particularly advantageous embodiment of the invention, the electric drive system has a first gear stage, which is also referred to as a first final drive. In relation to a first torque flow, along which the third torques can be discharged from the planetary gearbox via the first output shaft, the first gear stage is preferably arranged in the first torque flow and thus downstream of the first output shaft, i.e. connected downstream or positioned downstream of the first output shaft and thus in particular can be driven by the first output shaft. Expressed vice versa, the first output shaft is arranged in the first torque flow and thus upstream of the first gear stage, i.e. positioned upstream or connected upstream of the first gear stage.

Furthermore, it has proven to be particularly advantageous when the electric drive system has a second gear stage, which is also referred to as a second final drive. In relation to second torque flow, along which the fourth torques can be discharged from the planetary gearbox via the second output shaft, the second gear stage is preferably arranged in the second torque flow and thus downstream of the second output shaft. In other words, the second gear stage is arranged in the second torque flow and thus is connected downstream or positioned downstream of the second output shaft and thus in particular can be driven by the second output shaft. Expressed vice versa, the second output shaft is arranged in the second torque flow and thus upstream of the second gear stage, i.e. connected upstream or positioned upstream of the second gear stage. Thus, for example, a first of the drive wheels can be driven via the first gear stage of the first output shaft, i.e. can be driven by the third torques, and, for example, a second of the drive wheels and the second gear stage can be driven by the second output shaft, i.e. by the fourth torques.

In this case it has been proven to be particularly advantageous when the first gear stage, the second gear stage, the three planetary gear sets and the two rotors are arranged in a common housing of the electric drive system, wherein the housing for example, may be the aforementioned housing element or the aforementioned housing device.

In order to be able to keep the installation space of the electric drive system particularly low, it is provided in a further embodiment of the invention that the three planetary gear sets, the two rotors and the two gear stages are all arranged coaxially to each other.

It is conceivable that the respective gear stage is formed as a respective, further planetary gear set. Thus it is conceivable that the first gear stage is formed as a fourth planetary gear set and the second gear stage is formed as a fifth planetary gear set, wherein the fourth planetary gear set is provided in addition to the first planetary gear set, in addition to the second planetary gear set, in addition to the third planetary gear set and in addition to the fifth planetary gear set. Furthermore, it is preferably provided that a respective input of the respective, further planetary gear set, i.e. of the respective gear stage, is a respective, further sun gear of the respective further planetary gear set. Thus, for example, the third torques, discharged from the planetary gearbox via the first output shaft and provided in particular by the first output shaft, can be introduced into the first gear stage via the input, i.e. via the sun gear, of the first gear stage formed as a fourth planetary gear set. Furthermore, for example, the fourth torques, discharged from the planetary gearbox via the second output shaft and provided in particular by the second output shaft, can be introduced into the second gear stage via the input, i.e. via the sun gear, of the second gear stage formed as the fifth planetary gear set. Furthermore, for example, the respective, further planetary gear set has a respective, further annular gear and a respective further planetary carrier. In this case, it has proven to be particularly advantageous when the respective, further planetary carrier of the respective, further planetary gear set, i.e. of the respective gear stage, is a respective output or output drive of the respective gear stage. Thus, for example, the first gear stage, formed as a fourth planetary gear set, can provide fifth torques via its further planetary carrier, i.e. can discharge or dissipate fifth torques, wherein, for example, the fifth torques result from the third torques which are or were introduced into the first gear stage, in particular via the further sun gear of the first gear stage. Furthermore, for example, the second gear stage, formed as a fifth planetary gear set, can provide sixth torques via its further planetary carrier, i.e. can discharge or dissipate them, wherein, for example, the sixth torques result from the fourth torques which are or were introduced into the second gear stage, in particular via the further sun gear of the second gear stage. Furthermore, it has proven to be advantageous when the respective, further annular gear of the respective gear stage, formed as the fourth or fifth planetary gear set, is integral with the housing, i.e. is connected in particular permanently in a rotationally fixed manner to the housing, wherein the housing, for example, is the housing element and/or the housing device.

Furthermore, it has proven to be particularly advantageous when the planetary gearbox is formed or functions as the aforementioned planetary differential gearbox, in particular with a torque vectoring function. The planetary differential gearbox is also simply referred to as a differential gearbox, axle drive or differential, and as is already well known from the general prior art, is in particular formed to allow different speeds of the drive wheels, in particular when the motor vehicle is cornering, in particular in such a way that the outside drive wheel rotates or can rotate with a greater speed than the inside drive wheel. The torque vectoring function is also referred to as a torque distribution function or torque vectoring. In particular, this can be understood to mean the following: The electric drive system and thus the planetary gearbox are assigned to one, in particular to exactly one, of the axles and thus the wheels of the one axle, so that the drive wheels can be driven by means of the electric engines via the planetary gearbox. Since the planetary gearbox preferably functions or is formed as a planetary differential gearbox, the planetary gearbox allows different speeds of the drive wheels when the motor vehicle is cornering, in particular in such a way that the outside drive wheel rotates or can rotate with a greater speed than the inside drive wheel.

In this case, it is conceivable that a differential lock can be created by means of the blocking switching element, so that preferably at least or exactly any two elements of the planetary gearbox, still not connected in a rotationally fixed manner to each other, can be connected in a rotationally fixed manner to each other by means of the blocking switching element, wherein, for example, one of the elements that can be connected to each other in a rotationally fixed manner by means of the blocking switching element can be one of the first gear elements and the other of the elements that can be connected to each other in a rotationally fixed manner by means of the blocking switching element can be one of the second gear elements.

Also disclosed is a motor vehicle preferably designed as a motor car, in particular the aforementioned motor vehicle, wherein the motor vehicle has an electric drive system according to the invention. Advantages and advantageous embodiments of the electric drive system are considered to be advantages and advantageous embodiments of the motor vehicle and vice versa.

In particular, the electric drive system is a dual, electric axle drive having high variability, in order to be able to achieve a particularly high performance of the motor vehicle. The invention is thus based in particular on the following findings and considerations: Generally, axle differentials, i.e. differential gearboxes, are known from the prior art. A gearbox having an additional degree of freedom, which allows a certain degree of indeterminacy of specific kinematic sizes of the output shafts, which in the case of an axle differential is only eliminated by a mutual coupling of wheel speeds, i.e. of speeds of the drive wheels, via the ground contact. It follows from the conservation of energy that, apart from the energy losses, known as efficiency, which in most cases have to be dissipated to the environment as friction heat that cannot be utilised any further, the mechanical input power minus the heating power generated by friction losses corresponds to the mechanical output power. Axle differentials can be constructed as a triple-shaft gear mechanism in the planetary design, having an input shaft, driven by the drive engine, and two output shafts assigned to the drive wheels. In particular according to the prior art, a series of different embodiments are known. The kinematic behaviour of the axle drive, also simply referred to as a gearbox, specifies the torque behaviour of the two output shafts. This torque behaviour, also simply referred to as behaviour, is intrinsically constructively specified via the equilibrium conditions of the individual elements of the gearbox. The degree of freedom relates therefore exclusively to the speeds of the two output shafts and therefore also to the power output via these as the product of torque and speed. In addition, the efficiency-related conversion of part of the mechanical drive power and frictional heat results in an uneven distribution of the torque corresponding to the frictional torque of the gearbox if there is a differential speed between the output shafts. Due to the principle of least resistance, the slower shaft will always have or provide the higher torque, and the faster shaft the lower torque. Since this state can prove unfavourable in some driving situations, various approaches are known from the prior art to change the intrinsic torque distribution of axle drives or axle transmissions passively or, if necessary, actively. The simplest and most common method is to deliberately passively or, if necessary, actively change the internal friction of the axle differential or axle transmission, in particular to increase it, which can be achieved, for example, by so-called limited-slip differentials with frictionally locking coupling of the two output shafts, whereby two things can be achieved. Firstly, the imbalance of the moments released by the output shafts is increased by the amount of the increase in the internal friction, with the distribution direction remaining unchanged, in the sense that the slower shaft provides the higher torque, and the faster shaft provides the lower torque. Secondly, the additional friction torque counteracts build-up of the differential speed between the drive wheels, due to the coupling of the drive wheels via their contact with the ground. The two effects can have a positive impact in specific driving situations, so that in specific applications the associated reduction in the overall efficiency of the drive train of the vehicle is consciously accepted. There are also driving situations, however, in which increasing the internal friction of an axle differential has a negative impact, giving actively controlled systems an advantage over passive systems. This means that the possibilities of triple-shaft axle differentials to change the proportion of torque distributed to the drive wheels are, however, already completely exhausted.

In principle, it is conceivable that the blocking switching element connects at least or exactly two at least substantially arbitrary elements, in particular shafts, of the first planetary gear set and of the second planetary gear set to each other in a rotationally fixed manner, said elements not yet being connected to each other in a rotationally fixed manner, so that, for example, the planetary carrier of the first planetary gear set can be connected to the sun gear of the second planetary gear set, or the annular gear of the first planetary gear set can be connected to the annular gear of the second planetary gear set, or the annular gear of the first planetary gear set can be connected to the planetary carrier of the second planetary gear set, etc., all in a rotationally fixed manner by means of the blocking switching element, whereby blocking takes place in all these cases.

By evaluating possibilities that offer themselves for far-reaching driving dynamics support in driving situations in which the axle differentials described so far all prove to be disadvantageous, especially the fact that only the slower of the two output or side shafts can always be subjected to a higher torque than the faster one, for example, a consideration is made of a basic structure and a power balance of a three-shaft axle drive with a differential assumed to be symmetrical in this case, for example, according to the prior art. This shows that there are basically only two ways to change a given torque distribution of an axle differential, i.e. of an axle drive, in particular by enabling a random torque distribution (moment distribution) to the two drive wheels, regardless of existing speed differences.

The first possibility requires at least partial branching of the drive train, for which different variants are particularly suitable. A connection between the two side shafts may require that the redistributed torque ΔMᵤₙ must be able to have any sign, in order to allow any one of the two drive wheels to provide a higher torque. Any branching from the drive side to the respective side or output shafts must either be present on both sides, provided that the branched torque Mᵥ is always a positive drive torque, or can also be implemented on one side only, provided that the branched torque can have any sign. It should also be noted that angular velocities ωᵢ can be different, in particular that any one of the two side shafts can be faster than the other. Therefore, the required torque distribution or torque branching cannot usually be realised with kinematically clearly defined transmission means, such as meshing gears, but requires friction elements with slippage, for example friction couplings. This results in the additional condition that a torque can only be transmitted from the faster to the slower side via slipping couplings, which cannot be achieved without additional transmission stages in the parallel lines of the branched drive. It should also be noted that, due to the requirement for slipping wheel couplings, a further loss of efficiency in the drive train must inevitably be accepted. This must then be weighed against the advantages in terms of driving dynamics expected from such systems. The greatest advantage in terms of driving dynamics that can be achieved with such systems is when accelerating out of bends, wherein a yaw moment that steers into the bend around the vertical axis of the vehicle is achieved by increasing the torque on the faster wheel on the outside of the bend and correspondingly reducing the torque on the slower wheel on the inside of the bend, which supports the steering yaw moment of the steered front wheels, thereby relieving the load on the front wheels and creating a driving behaviour that is perceived as very agile, also because the grip limit of the tyres, which are dynamically loaded to different degrees vertically, can be used safely to a greater extent when accelerating out of bends. Systems of such type are also known under the term torque vectoring. Alongside all-wheel drive, such systems are by far the most effective for improving the effective and subjective agility and thus also the driveability and safety of road vehicles in all driving situations relevant to lateral dynamics.

In principle, the second possibility results from a consideration of a power balance of the axle drive. The energy analysis clearly shows that if the disturbance torque introduced by the inherent internal friction of the gearbox and/or by the possibly intentionally increased friction (friction discs in the limited slip differential), which generates a heating power, has a negative effect on the mechanical energy balance of the drive, it is imperative that the slower shaft is always allocated the torque increased by half of this disturbance torque and the faster shaft is allocated the torque reduced by half of the disturbance torque. In order to overcome this mandatory relationship, a disturbance torque with a positive effect on the mechanical energy balance would have to be introduced into the axle drive. However, this can only be introduced as an additional drive power, independent of that of the M_{anω0}, which is assumed to be the only drive machine. If this is to be achieved in any other way than via at least partially branched drive trains, a second drive machine, i.e. drive engine, is absolutely necessary. Due to the high complexity of the internal combustion engines used exclusively in the past, such considerations were only taken into account in a few exceptional cases, but this is changing in times of increasing electromobility, especially in the field of highly motorised vehicles; twin-engine axle drives are suitable for such purposes in various configurations. An advantageous solution initially appears to be the use of two identical, wheel-individual motors or electric engines, each of which drives one wheel of the axle completely independently of the other, for example. By individual control of these two motors or engines, it appears possible to apply any torque within the scope of the performance of the motors or engines of the respective wheel connected to them in a rotationally fixed manner. As a result, all of the previously described restrictions on possible torque distributions to the drive wheels, in particular the restrictions dependent on the speed difference between the two drive wheels, especially axle drives, appear to have been lifted. However, an analysis of the driving dynamics situation that arises when accelerating out of a bend showed that wheel-individual motors or electric engines cannot achieve torque vectoring, which can be realised with corresponding methods of torque transfer or torque branching via an at least partially branched drive train in the area of the drive axle. Wheel-individual drives reach their limits shortly before one of the motors, in particular the motor of the outer wheel, reaches its power limit during acceleration. After that, there is only limited torque vectoring and/or acceleration capability, especially if, for reasons of driveability, the steering yaw moment around the vertical axis of the vehicle, which was applied by the torque vectoring up to that point, is to be prevented from dropping, which the driver would perceive as an unexpected onset of understeer. In order to avoid such understeer, in the case of lateral acceleration, the total power output of both engines should generally be reduced by usually around 17 to 20 percent, depending on the design and/or engine of the vehicle, even at 100 percent accelerator pedal position, which can be a serious disadvantage, especially for vehicles designed for agile driving.

Mechanical coupling systems, which enable torque transfer between the two motors or engines and thus also between the two wheels of an axle, can provide a possible remedy. However, reference should again be made to the possibly different speeds of the output shafts, which shows that three-shaft gearboxes, such as a classic axle differential according to the state of the art, are not expedient, because the introduction of a disturbance torque with a second electric engine into one of the two side shafts, only allows this second engine the possibility of modulating the drive torques transmitted to the respective wheels and therefore it cannot be regarded as a fully-fledged drive engine, as it cannot meaningfully participate in the drive during straight-ahead travel, for example, which means that not all of the installed power can be converted during straight-ahead travel. In order to keep open the option of being able to use both drive engines as effectively usable drive engines, at least four-shaft coupling gears should be considered instead of the classic three-shaft axle differential.

It could be considered a disadvantage that a four-shaft axle drive is dependent on the provision of torques from both motors in all driving situations, in the sense that both motors must always be driving in order to transmit an appropriate torque distribution to both drive wheels of the axle in the respective driving situation. This can be considered uneconomical, especially for high-performance vehicles, for example in urban operation with low power requirements. This disadvantage can be avoided by the invention, in particular with simultaneous realisation of torque vectoring, in particular when accelerating out of a bend.

For example, one of the electric engines is a first, powerful drive engine M1, in particular of any power and torque capacity, whereby the other electric engine is a second drive engine M2, for example, which only has to achieve at most 63 percent of the torque capacity of the first drive engine M1. This makes it possible, for example, to design the drive engine M1 with optimised performance and the drive engine M2 with optimised efficiency. With the M1 and M2 drive engines, sufficient torque vectoring in terms of driving dynamics can be maintained far beyond the possibilities of wheel-individual solutions. For example, the onset of understeer when accelerating out of a bend, as described above, can be avoided by reducing the total motor power by just 6 percent. As a result, a significantly more dynamic and more agile driving behaviour can be achieved with less total installed drive power than would be possible with two wheel-individual motors.

If, for example, drive torques MdAb1 and MdAb2 transmitted to the output shafts, also known as side shafts, are represented in a diagram by two straight lines, the intersection or intersection point of the straight lines represents the so-called differential point. In this differential point operation, a coupling gear formed by the first and second planetary gear sets behaves in exactly the same way as a symmetrical axle differential with regard to the half torque distribution to each of the drive wheels and the enabling of an independently existing or forced speed difference of the drive wheels of the axle. This state also corresponds to that when travelling straight ahead, with both drive wheels each receiving half of the drive torque. Such a state exists for any total load of the two drive motors or drive engines, provided that the corresponding torque ratio of both engines is maintained. This results in a corresponding control scheme for a straight-line acceleration process for all possible total load ranges of both motors and therefore a torque output of the electric engines, also known as motors.

For example, at any given total load point, the ratio of the torques of the drive engines M1 and M2 is 1.667. This ratio is predetermined by the intrinsic behaviour of the coupling system with stationary transmission ratios +2−2. When operated with this torque ratio, the coupling gear behaves like a symmetrical axle differential, regardless of the amount of total torque applied. This circumstance is preferably utilised in order to make such an axle drive additionally suitable for single-engine operation in the low power range required, so that in single-engine operation, for example, the drive wheels are driven exclusively by one of the electric engines in relation to the electric engines. For example, an additional, single planetary gear set such as the third planetary gear set is used as an asymmetrical distribution gear, in particular in the form of the third planetary gear set. This planetary gear set is integrated into the axle drive so that one of the drive engines M1 and M2 is disengaged from the drive of the coupling gear by means of a preferably form-fitting switching element and is connected to the bridge of the axially symmetrical distribution gear as a drive Man. Simultaneously, the other motor or the other drive engine M2 or M1 is similarly separated from the coupling gear, without connecting it to another element. Therefore, this drive engine is completely separated, it is not active anymore. The torque introduced into the bridge of the asymmetrical distribution gear from the motor, which continues to be active on its own, will generate equal tangential forces on the two diametrically opposed sides of the planetary gear, which mesh with a central sun gear and an annular gear, to equalise the motor torque introduced. Accordingly, the ratio of the two output torques M_{HR} and M_{SO} from the asymmetrical distribution gear is permanently constant and equal to the stationary transmission ratio, regardless of the possibly different speeds of the elements of the asymmetrical distribution gear due to the ratio of the pitch circles of the sun gear and the annular gear.

If the ratio of the two output torques M_{HR} and M_{SO} of the asymmetrical distribution gear corresponds to the required ratio of the drive torque of the coupling gear in order to operate it at the differential point, for example it is exactly 1.667, then the combination of the asymmetrical distribution gear and the coupling gear, driven jointly by a single motor, can simulate the function of a symmetrical differential. Thus, the axle drive can be driven with only one of the two motors M1 or M2. The axle drive behaves like a so-called open, symmetrical differential with half of the torque distributed to the two drive wheels, regardless of any different speeds of the two drive wheels. The fact that for any number of teeth of the annular gear of the asymmetrical distribution gear, which is a multiple of five, the required transmission ratio of 1.667 can be achieved precisely with an integer number of teeth of the sun gear is particularly favourable, as the following applies:

$$\frac{5 \times N}{3 \times N} = 1.667$$

for every natural number N, which simplifies the design of the asymmetrical distribution gear.

In summary, it can be stated that usually reduced planetary coupling gears, which enable the realisation of torque vectoring-capable axle drives with two electric engines as drive or travelling engines, usually necessitate a permanent drive via both electric engines or by means of both electric engines. In contrast, however, the invention now enables the aforementioned single-engine operation, i.e. a single-engine operation of such drive axles, whereby a particularly efficient drive can be realised. For this purpose, the third planetary gear set can be used in the invention, for example, as an asymmetrical distribution gear, by means of which a torque acting as a drive torque and provided by precisely one of the electric engines or by precisely one of the rotors is broken down into advantageous components in order to operate a coupling gear, formed by the first planetary gear set and the second planetary gear set, at its differential point in order to enable the drive wheels to be driven by means of the precisely one electric engine. The single-engine operation is thus a particularly energy-efficient and thus economical mode of operation. Coupling systems that can be operated with electric engines with different outputs are particularly favourable, as the less powerful electric engine, which is preferably designed to optimise efficiency, can be used as the only drive engine in an efficient mode. Therefore, the drive is characterised by a particularly high variation between the operating efficiency, or efficiency, and performance.

Further advantages, features and details of the invention can be seen from the following description of preferred exemplary embodiments and from the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

In the drawings:

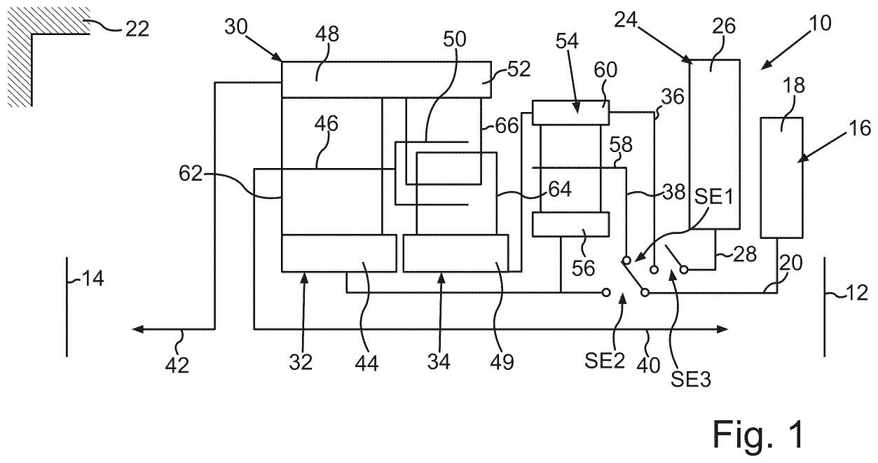

FIG. 1 shows a schematic representation of a first embodiment of an electric drive system for a motor vehicle;

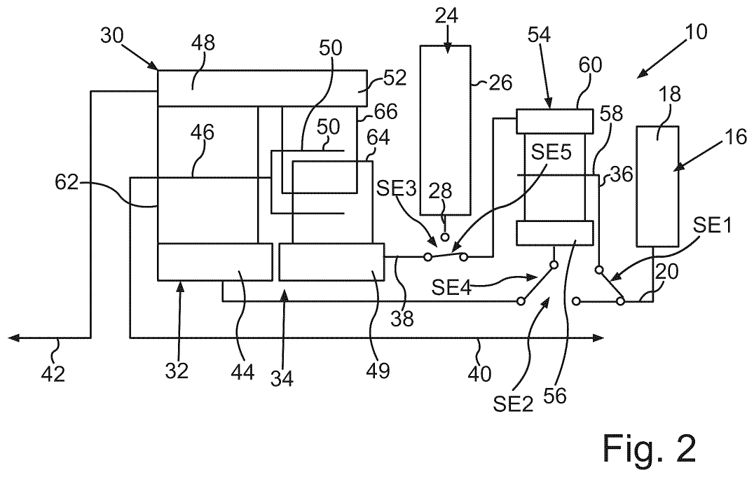

FIG. 2 shows a schematic representation of a second embodiment of the electric drive system;

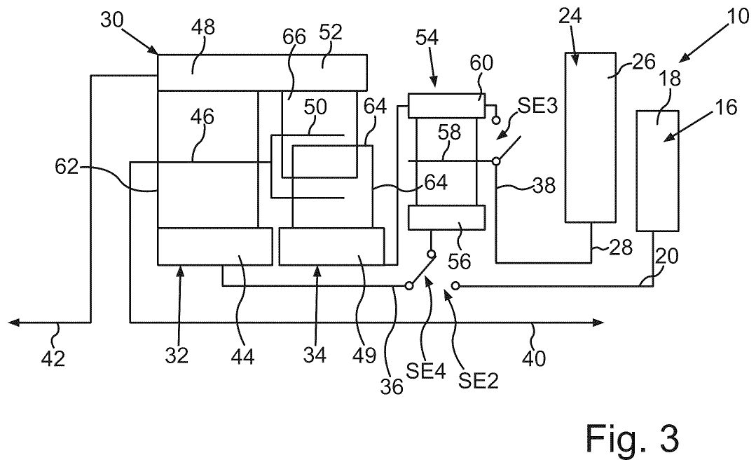

FIG. 3 shows a schematic representation of a third embodiment of the electric drive system; and

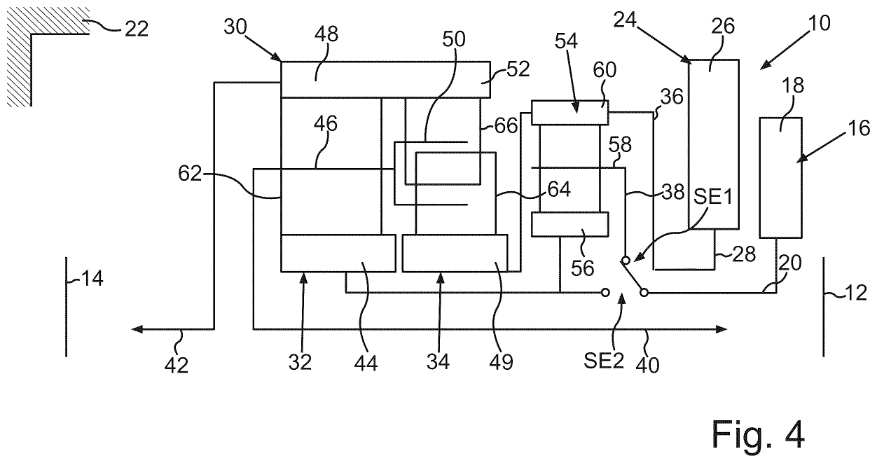

FIG. 4 shows a schematic representation of a fourth embodiment of the electric drive system.

In the figures, identical or functionally identical elements are provided with the same reference numerals.

FIG. 1 shows a schematic representation of a first embodiment of an electric drive system 10 for a motor vehicle, in particular for a motor car. Thus, in its completely produced state, the motor vehicle also simply referred to as a vehicle has the electric drive system 10, by means of which the motor vehicle can be driven electrically, in particular purely electrically. The motor vehicle has at least or exactly two axles arranged in succession in the vehicle longitudinal direction and thus one behind the other. The respective axle has at least or exactly two wheels, also referred to as vehicle wheels, wherein the respective wheels of the respective axle are arranged on the opposite side of the motor vehicle to each other in the vehicle transverse direction. For example, the drive system 10 is assigned at least or exactly one of the axles, so that at least or only the wheels of the axle, which is assigned to the electric drive system 10, can be driven by means of the electric drive system 10. The wheels driven by means of the electric drive system 10 are also referred to as drive wheels. The drive wheels are represented particularly schematically in FIG. 1 and referenced with 12 and 14. The motor vehicle can be driven electrically, in particular purely electrically, by electrically, in particular purely electrically, driving the drive wheels 12 and 14 by means of the drive system 10. The drive system 10 has a first electric engine 16 which has a first stator 18 and a first rotor 20. The rotor 20 can be driven by means of the stator 18 and thus can be rotated around a first engine rotational axis, relative to the stator 18. The drive system 10 has a housing 22 represented particularly schematically in FIG. 1, which is also referred to as a housing device or housing element. In this case, the rotor 20 can be rotated around the first engine rotational axis, relative to the stator 18 and relative to the housing 22. The drive system 10 further comprises a second electric engine 24 which has a second stator 26 and a second rotor 28. The rotor 28 can be driven by means of the stator 26 and thus can be rotated around a second engine rotational axis, relative to the stator 26 and relative to the housing 22. In the first embodiment example, shown in FIG. 1, the electrical engines 16 and 24 are arranged coaxially to one another so that the engine rotational axes coincide. The electric engine 16 can provide first torques via its rotor 20, which are also referred to as first moments or first drive moments or first drive torques, and the second electric engine 24 can provide second torques via its second rotor 28, which are also referred to as second moments, second drive moments or second drive torques.

The drive system 10 has a planetary gearbox 30 which has a first planetary gear set 32 and a second planetary gear set 34. For example, the planetary gear sets 32 and 34 form a coupling gear. In particular, the planetary gearbox 30, in particular the coupling gear, may be a differential gearbox, which can also be referred to as a differential, axle differential or axle drive. The differential gearbox is a planetary differential gearbox, in particular with a torque distribution function also known as torque vectoring or torque vectoring function.

The planetary gearbox 30 has a first input shaft 36, a second input shaft 38, a first output shaft 40 and a second output shaft 42. The first input shaft 36 is formed to introduce first torques into the planetary gearbox 30, emanating from the first electric engine 16, i.e. provided by the electric engine 16 via the rotor 20 and thus by the rotor 20. The second input shaft 38 is formed to introduce second torques into the planetary gearbox 30, emanating from the second electric engine 24, i.e. the second torques provided by the electric engine 24 via the rotor 28 and thus by the rotor 28. The first output shaft 40 is formed to discharge third torques from the planetary gearbox 30, which third torques, for example, result from the first torques and/or second torques introduced into the planetary gearbox 30. The second output shaft 42 is formed to discharge fourth torques from the planetary gearbox 30, which fourth torques, for example, result from the first torques and/or second torques introduced into the planetary gearbox 30. The third torques are, for example, also referred to as first drive torques or first drive moments, and the fourth torques are, for example, also referred to as second drive torques or second drive moments. In particular, the respective torque can also be simply referred to as a moment.

The first planetary gear set 32 has a first sun gear 44 and a first planetary carrier 46. Furthermore, the first planetary gear set 32 has a first annular gear 48. The second planetary gear set 34 has a second sun gear 49, a second planetary carrier 50 and a second annular gear 52.

In the first embodiment, the first sun gear 44 of the first planetary gear set 32 is a first element of the first planetary gear set 32, whose first element can be connected to the first rotor 20 in a rotationally fixed manner. In the first embodiment, the first planetary carrier 46 is a second element of the first planetary gear set 32, whose second element is connected to the first output shaft 40, in particular permanently, in a rotationally fixed manner. Furthermore, in the first embodiment, the first annular gear 48 is a third element of the first planetary gear set 32, whose third element is connected to the output shaft 42, in particular permanently, in a rotationally fixed manner. In the first embodiment, the second sun gear 49 of the second planetary gear set 34 is a fourth element of the second planetary gear set 34, whose fourth element can be connected to the second rotor 28 in a rotationally fixed manner. Furthermore, in the first embodiment, the second planetary carrier 50 of the second planetary gear set 34 is a fifth element of the second planetary gear set 34, whose fifth element is connected, in particular permanently, in a rotationally fixed manner to the second element, presently to the first planetary carrier 46.

In order to realise particularly advantageous driveability and a particularly compact design and particularly efficient operation, the second planetary gear set 34 has a sixth element, which in the first embodiment is the second annular gear 52 and which is connected, in particular permanently, in a rotationally fixed manner to the third element in the first embodiment with the annular gear 48. Furthermore, the planetary gearbox 30 and thus the drive system 10 have a third planetary gear set 54, in addition to the planetary gear sets 32 and 34, which has a third sun gear 56, a third planetary carrier 58 and a third annular gear 60. In the first embodiment, the third sun gear 56 of the third planetary gear set 54 is a seventh element of the third planetary gear set 54, whose seventh element, in the first embodiment, is connected, in particular permanently, in a rotationally fixed manner to the first element, presently to the first sun gear 44. In the first embodiment, the third planetary carrier 58 of the third planetary gear set 54 is an eighth element of the third planetary gear set 54, whose eighth element can be connected to the first rotor 20 in a rotationally fixed manner in the first embodiment. Furthermore, in the first embodiment, the third annular gear 60 of the third planetary gear set 54 is a ninth element of the third planetary gear set 54, whose ninth element, in the first embodiment, is connected, in particular permanently, in a rotationally fixed manner to the fourth element, i.e. presently to the second sun gear 49. Thus, in the present case, the second sun gear 49 can be connected in a rotationally fixed manner to the second rotor 28 via the third annular gear 60, which is in particular permanently connected to the second sun gear 49 in a rotationally fixed manner, said second rotor being able to be connected to the third annular gear 60 in a rotationally fixed manner.

Furthermore, it is provided in the first embodiment that a first stationary transmission ratio, also designated i1, of the first planetary gear set 32 has the same absolute value and an opposite mathematical sign compared to a second stationary transmission ratio, also designated i2, of the second planetary gear set 34, it being provided in particular in the first embodiment that the first stationary transmission ratio i1 is −2 and the second stationary transmission ratio i2 is +2. The third planetary gear set 54 has a third stationary transmission ratio, also designated i0, which for example in the first embodiment is 5/3, i.e. 1.667.

The third planetary gear set 54 is in particular an asymmetrical distribution gear or can be used in particular as an asymmetrical distribution gear, by means of which, for example, total torque, introduced into the distribution gear can be or is broken down into advantageous and/or required components, in particular in order to operate the coupling gear in its differential point. The total torque results, for example, from the respective first torque, introduced into the distribution gear, and/or from the respective second torque, introduced into the distribution gear. The components are for example each torques which are or can be introduced in particular from the distribution gear into the coupling gear, in the present case for example via the sun gears 44 and 49. For example, the drive system 10 can be operated in a single-engine operation, in which in relation to the electric engines 16 and 24, only one of the electric engines 16 and 24 provides the respective drive torque. In particular, in the single-engine operation, the total torque results from the drive torque, provided by the exactly one electric engine 16 or 24. The respective electric engine 16 or 24 is also referred to as a motor, engine or drive engine.

In the first embodiment, the first planetary carrier 46 is formed as a single planetary carrier, on which first planetary gears 62 are rotatably held or mounted. The respective, first planetary gear 62 meshes for example, in particular simultaneously, with the first sun gear 44 and with the first annular gear 48. In the first embodiment, the second planetary carrier 50 is formed for example as a double planetary carrier, on which second planetary gears 64 and third planetary carriers 66 are rotatably held, in particular mounted.

In this case, it is possible that the second planetary gears 64 are engaged with the second sun gear 49, but not engaged with the second annular gear 52, but are engaged with the third planetary gears 66. Furthermore, the third planetary gears 66 are engaged with the second annular gear 52, but not engaged with the second sun gear 49, but are engaged with the second planetary gears 64. Thus, for example, the second sun gear 49 meshes with the second planetary gears 64, and the third planetary gears 66 mesh with the second annular gear 52, whereby the planetary gears 64 and 66 each mesh with each other. Furthermore, the planetary gears 64 do not mesh with the second annular gear 52, and the planetary gears 66 do not mesh with the second sun gear 49. Furthermore, the first planetary gears 62 are formed to be separate from the second planetary gears 64 and to be separate from the third planetary gears 66.

Preferably, it is provided that the third element and the sixth element have the same toothing diameter and the same number of teeth. Furthermore, it is preferably provided that the eighth element is formed as a sum shaft of the third planetary gear set 54.

In the first embodiment, the electric drive system 10 has a first switching element SE1, by means of which the first rotor 20 can be connected in a rotationally fixed manner to the eighth element, i.e. presently to the third planetary carrier 58 of the third planetary gear set 54. Furthermore, the drive system 10 has a second switching element SE2, by means of which the first element, i.e. presently the first sun gear 44 of the first planetary gear set 32, can be connected in a rotationally fixed manner to the first rotor 20. Furthermore, in the first embodiment, the electric drive system 10 has a third switching element SE3, by means of which in the first embodiment, the fourth element, i.e. presently the second sun gear 49 of the second planetary gear set 34, can be connected in a rotationally fixed manner to the second rotor 28.

According to FIG. 1, the drive system 10 is located in such a switching state in which the third planetary carrier 58 is connected in a rotationally fixed manner to the first rotor 20 by means of the first switching element SE1, wherein the second switching element SE2 is open and thus allows relative rotations to take place between the first rotor 20 and the first sun gear 44 around the second engine rotational axis, and wherein the third switching element SE3 is open and allows relative rotations to take place between the second rotor 28 and the third annular gear 60 around the second engine rotational axis. According to FIG. 1, thus the second rotor 28 or the electric engine 24 is decoupled or disconnected from the planetary gearbox 30, which, for example, can be the case in the single-engine operation or whereby the single-engine operation can be realised by means of the first electric engine 16.

Furthermore, it is provided in the first embodiment that the input shaft 36 is connected, in particular permanently, in a rotationally fixed manner to the annular gear 60, wherein the input shaft 36 is connected, in particular permanently, in a rotationally fixed manner to the second sun gear 49, in particular via the annular gear 60. Furthermore, in the present case, the input shaft 38 is, for example, connected, in particular permanently, in a rotationally fixed manner to the planetary carrier 58 which, for example, is formed as a single planetary carrier in the first embodiment.

FIG. 2 shows a second embodiment of the drive system 10, in a schematic representation. In the second embodiment, the drive system 10 has a first switching element SE1, by means of which the first rotor 20 can be connected in a rotationally fixed manner to the eighth element, in the present case to the third planetary carrier 58 of the third planetary gear set 54. Furthermore, in the second embodiment, the drive system 10 has a second switching element SE2, by means of which the first rotor 20 can be connected in a rotationally fixed manner to the first element, in the present case to the first sun gear 44 of the first planetary gear set 32. Furthermore, in the second embodiment, the drive system 10 has a third switching element SE3, by means of which the second rotor 28 can be connected in a rotationally fixed manner to the fourth element, in the present case to the second sun gear 49 of the second planetary gear set 34.

Furthermore, a fourth switching element SE4 is provided, by means of which the seventh element, in the present case the third sun gear 56 of the third planetary gear set 54, can be connected in a rotationally fixed manner to the first element, in the present case to the first sun gear 44. Furthermore, a fifth switching element SE5 is provided, by means of which the ninth element, in the present case the third annular gear 60, of the third planetary gear set 54 can be connected in a rotationally fixed manner to the fourth element, in the present case to the second sun gear 49 of the second planetary gear set 34.

FIG. 2 shows the second embodiment in a state in which the first switching element SE1 is closed, the second switching element SE2 is open, the third switching element SE3 is open, the fourth switching element SE4 is closed and the fifth switching element SE5 is closed.

FIG. 3 shows a third embodiment of the drive system 10. In the third embodiment, the ninth element, in the present case the third annular gear 60, is connected permanently in a rotationally fixed manner to the fourth element, in the present case to the second sun gear 49. Furthermore, the second rotor 28 is connected permanently in a rotationally fixed manner to the eighth element, i.e. to the third planetary carrier 58.

In this case, a third switching element SE3 is provided, by means of which the ninth element, in the present case the annular gear 60, can be connected in a rotationally fixed manner to the second rotor 28 and thus to the eighth element, i.e. to the planetary carrier 58. The third switching element SE3 consequently also connects the fourth element, i.e. the second sun gear 49, in a rotationally fixed manner to the second rotor 28.

A second switching element SE2 is also provided, by means of which the first rotor 20 can be connected in a rotationally fixed manner to the first element, i.e. the first sun gear 44. Furthermore, a fourth switching element SE4 is provided, by means of which the seventh element, here the third sun gear 56, can be connected in a rotationally fixed manner to the first element, here the first sun gear 44.

FIG. 3 shows the third embodiment in a state in which the second switching element SE2 is open, the third switching element SE3 is similarly open and the fourth switching element SE4 is closed.

In the embodiment of FIG. 3, preferably and as in the embodiment of FIG. 2, the second switching element SE2 and the fourth switching element SE4 can be combined to form a further common two-position switching element with a single actuator.

The second electric engine 24 is also designated with M1, and the first electric engine 16 is also designated with M2. In this case, preferably the engine M1 is a power-optimised engine, i.e. a power-optimised motor and thus the more powerful of the two engines M1 and M2 also referred to as motors.

In particular, in the first embodiment of FIG. 1, the engine M1 can be disconnected from the planetary gearbox 30 by means of the preferably form-fitting third switching element SE3 of in particular any design, i.e. for example, can be separated from any other elements of the drive system 10, also referred to as a drive. In single-engine operation in particular, the drive wheels 12 and 14 are driven in relation to the engines M1 and M2 exclusively by means of the engine M2, or the engine M2, whose output torque, also referred to as engine torque, is introduced via the preferably form-fitting first switching element SE1 into the bridge, i.e. into the third planetary carrier 58, of the third planetary gear set 54 which is designed or acts as an asymmetrical distribution gear.

In a particularly favourable embodiment of FIG. 1, it is conceivable that the switching elements SE1 and SE2 are combined to form a first common switching element and are actuated, i.e. switched, by means of a single, common actuator, since they can preferably always be actuated in opposite directions for a change between two operating modes of the drive system 10. A first operating mode is a single-motor operation, for example. A second of the operating modes is, for example, a mode in which both engines M1 and M2 provide drive torques and thus drive the drive wheels 12 and 14, in particular simultaneously, in particular in such a way that the two engines M1 and M2 are coupled in a torque-transmitting manner with the planetary gearbox 30. The drive torque of the engine M2, for example, is divided via the annular gear and sun of the asymmetrical distribution gear into the ratio of 1.667 corresponding to the operation of the coupling gear at its differential point and is introduced into the two sun gears 44 and 49 of the coupling gear; for example, the higher torque of the annular gear is introduced into the sun of the planetary stage with the stationary transmission ratio +2 of the coupling gear, the lower torque of the sun of the asymmetrical distribution gear is introduced into the sun of the planetary stage with the stationary transmission ratio −2 of the coupling gear. This means that the drive, also known as the axle drive, behaves in the same way as a three-shaft, symmetrical differential with the efficiency-optimised engine M2 as the only drive. This results in a particularly favourable configuration, as the drive in an energy-efficient mode with low power requirements can be provided exclusively by the less powerful, efficiency-optimised engine M2, which means that the vehicle can be operated in a particularly favourable energy consumption mode in the low power requirements range, especially in the form of single-engine operation.

When travelling straight ahead, if there is no differential speed between the drive wheels 12 and 14 of the axle, the coupling gear and the asymmetrical distribution gear rotate in the block at the same speed without causing rolling losses in the gearing. In order to realise the second operating mode, also known as power or performance mode, the engine M1 is connected to the second sun gear 49 of the planetary stage of the coupling gear with the stationary transmission ratio +2 via the annular gear 60 of the asymmetrical distribution gear by means of the switching element SE1, for example, and the engine M2 is connected, in particular directly, to the first sun gear 44 of the planetary stage with the stationary transmission ratio −2 of the coupling gear by means of the preferably form-fitting switching element SE3. This achieves an advantageous, in particular simultaneous, connection of the engines M2 and M1 to the coupling gear, whereby the axle drive allows particularly extensive, actuator-less torque vectoring solely via the corresponding electrical control of the engines M1 and M2. When travelling straight ahead, if there is no differential speed between the drive wheels 12 and 14 of the axle and the two engines M1 and M2 are driven at the same speed, the coupling gear and the asymmetrical distribution gear rotate in the block at the same speed without causing rolling losses in the gearing.

As the coupling gear behaves symmetrically in relation to the sign of the transmitted torque, not only is actuator-less torque vectoring possible when the vehicle is in traction mode, but also this opens up extensive possibilities for an actuator-less eABS and/or eESP when the vehicle is in overrun mode, in the recuperation mode of the engines M1 and M2. A particular advantage of such systems in terms of driving dynamics is the higher achievable cycle frequency of the modulation via the control of the engines M1 and M2 compared to classic ABS and/or ESP systems, which generally act via the hydraulic vehicle brake.

In particular in the second embodiment, it is possible that in the second operating mode, the asymmetrical distribution gear can be completely decoupled from the power flow. As a result, a corresponding design of the preferably form-fitting switching elements SE1, SE2, and where appropriate SE4, is conceivable. In order to operate this configuration of the axle drive, in particular in the first operating mode with the efficiency-optimised engine M2, the engine M1 is decoupled from the planetary gearbox 30, and in particular at the same time the annular gear 60 of the asymmetrical distribution gear (third planetary gear set 54) is connected in a rotationally fixed manner to the second sun gear 49 of the planetary stage with the stationary transmission ratio +2 of the coupling gear. Furthermore, the engine M2, in particular its rotor, is preferably connected in a form-fitting, rotationally fixed manner with the bridge, i.e. with the third planetary carrier 58 of the asymmetrical distribution gear. Furthermore, preferably, the third sun gear 56 of the asymmetrical distribution gear is connected in a rotationally fixed manner to the first sun gear 44 of the planetary stage with the stationary transmission ratio −2 of the coupling gear.

Preferably, it is provided in the second embodiment of FIG. 2 that the switching elements SE2 and SE4 are combined to form a second common switching element with two stages. In particular, this two-stage nature is to be understood in such a way that it is possible to switch between a stage S1, in which the first element, i.e. the first sun gear 44, is connected in a rotationally fixed manner to the first rotor 20, and a stage S2, in which the first element, i.e. the first sun gear 44, is connected in a rotationally fixed manner to the seventh element, i.e. the third sun gear 56.

With regard to the second embodiment, in the second operating mode, the third switching element SE3 connects the engine M1 or its second rotor 28, in particular in a form-fitting manner, in a rotationally fixed manner to the second sun gear 49 of the planetary stage with the stationary transmission ratio +2 of the coupling gear, and the second switching element SE2 connects the engine M2 or its first rotor 20, in particular with in a form-fitting manner, in a rotationally fixed manner to the first sun gear 44 of the planetary stage with the stationary transmission ratio −2 of the coupling gear. For example, the second stage S1′ of the second common switching element or the fourth switching element SE4 is inactive, so that, for example, the third sun gear 56 is not connected to the first sun gear 44 in a rotationally fixed manner. As a result, an advantageous power flow can be realised, wherein the torque vectoring function can be achieved with the aid of the two engines M1 and M2. Furthermore, this allows the asymmetrical distribution gear to be completely removed from the power flow; none of its elements are externally connected to any other element of the axle drive, which means that an efficiency advantage can be achieved.

Overall, it is conceivable that in the energy-efficient first operating mode, in relation to the engines M1 and M2, only the more powerful engine M1 can be used or is used for the drive, while the respective other engine, in particular engine M2 in the present case, is switched off. In the second operating mode, the drive wheels 12 and 14 are for example driven by means of the two engines M1 and M2, whereby a particularly advantageous torque distribution function can be achieved.

In addition, further designs of the same principle, which enables more extensive torque vectoring than is possible with two wheel-individual, mutually independent motors, are also to be considered as covered by herewith using an asymmetrical distribution gear with the planetary stages of the coupling system linked to the stationary transmission ratio. In the case of the embodiments described here with the stationary transmission ratios +2−2 of the individual planetary stages forming the coupling system, wherein the asymmetrical distribution gear has the stationary transmission ratio 1.667 in order to operate the coupling gear with a single drive engine, the possibility shown of operating a thoroughly powerful axle drive that is particularly advantageous in terms of driving dynamics with only the less powerful and therefore preferably efficiency-optimised engine M2 in the first operating mode stands out as particularly advantageous from the mass of possibilities. This means that a vehicle that is particularly powerful in terms of driving dynamics in the second operating mode can be operated particularly economically in the single-engine mode (first operating mode) within the range of low power requirements, whereby a particularly high variability of vehicle use can be ensured.

In order to further improve the driving dynamics of the vehicle, all of the variants or embodiments presented can be supplemented with a differential lock, which is available, for example, as an actively controllable friction coupling between the bridge and the annular gear of the coupling gear, for example between the planetary carrier 46 or 50 and the annular gear 48 or 52.

If, in the second embodiment shown in FIG. 2, the second switching element SE2 and the fourth switching element SE4 are not combined to form a common switching element, the switching element SE2 can act as a blocking switching element for the third planetary gear set 54 if the first rotor 20 is connected in a rotationally fixed manner to the eighth element and if, in this second embodiment, the seventh element is connected in a rotationally fixed manner to the first element.

With regard to the third embodiment, the engine M1 or its second rotor 28 is preferably permanently connected in a rotationally fixed manner to the eighth element, and the ninth element is preferably permanently connected in a rotationally fixed manner to the fourth element, and the third switching element SE3 is designed here as a blocking switching element for the third planetary gear set 54.

Finally, FIG. 4 shows a fourth embodiment, which is almost identical to the first embodiment shown in FIG. 1.

As a substantial difference to the first embodiment, in the fourth embodiment, the first rotor 20 and the fourth element are connected permanently in a rotationally fixed manner to each other. In other words, in the preferred embodiment shown here, the second sun gear 49 and the second rotor 20 are connected permanently in a rotationally fixed manner to each other. In the fourth embodiment, the third switching element SE3 is thus omitted.

A significant advantage of this embodiment is the combination of the first switching element and the second switching element (each in the form and function of the first embodiment) with the feature of the permanently rotationally fixed connection of the second rotor to the fourth element or the second sun gear.

In the fourth embodiment, quasi-single-engine operation is also possible, in which the drive wheels 12 and 14 are driven almost exclusively by the efficiency-optimised engine M2 in relation to the engines M1 and M2, in this case via the first electric engine 16 or its first rotor 20. For the purpose of this quasi-single-engine operation of the fourth embodiment, the first switching element SE1 is closed, whereby the first rotor 20 is connected in a rotationally fixed manner to the third planetary carrier 58. The second switching element SE2 is open in the single-engine operation of the fourth embodiment. In FIG. 4, the switching state of this single-engine operation of the fourth embodiment is represented. The engine M1, i.e. the second electric engine 24, thus rotates with no load, or else largely symmetrical torque vectoring can be achieved by applying a comparatively low (positive or negative) torque via the second electric engine 24.

An advantage of the fourth embodiment is that torque vectoring capability is provided in all switching states. In addition, one switching element is saved compared to the first embodiment. The disadvantage of (low) efficiency losses in the quasi-single-engine operation of the fourth embodiment can therefore be accepted, at least if the two electric engines 16, 24 are suitably designed.

### LIST OF REFERENCE NUMERALS

10 drive system
12 drive wheel
14 drive wheel
16 first electric engine
18 first stator
20 first rotor
22 housing
24 second electric engine
26 second stator
28 second rotor
30 planetary gearbox
32 first planetary gear set
34 second planetary gear set
36 first input shaft
38 second input shaft
40 first output shaft
42 second output shaft
44 sun gear
46 planetary carrier
48 annular gear
49 sun gear
50 planetary carrier
52 annular gear
54 third planetary gear set
56 sun gear
58 planetary carrier
60 annular gear
62 planetary gear
64 planetary gear
66 planetary gear
SE1 switching element
SE2 switching element
SE3 switching element
SE4 switching element
SE5 switching element

1. Electric drive system (10) for a motor vehicle, having a first electric engine (16) with a first rotor (20), a second electric engine (24) with a second rotor (28), and a planetary gearbox (30), which has a first planetary gear set (32), a second planetary gear set (34), a first input shaft (36), a second input shaft (38), a first output shaft (40) and a second output shaft (42), wherein:
the first input shaft (36) is formed to introduce first torques, emanating from the first electric engine (16), into the planetary gearbox (30),
the second input shaft (38) is formed to introduce second torques, emanating from the second electric engine (24), into the planetary gearbox (30),
the first output shaft (40) is formed to discharge third torques from the planetary gearbox (30),
the second output shaft (42) is formed to discharge fourth torques from the planetary gearbox (30),
the first planetary gear set (32) has a first element, which can be connected in a rotationally fixed manner to the first rotor (20), a second element, connected in a rotationally fixed manner to the first output shaft (40), and a third element, connected in a rotationally fixed manner to the second output shaft (42),
the second planetary gear set (34) has a fourth element, which is or can be connected in a rotationally fixed manner to the first rotor (20), and a fifth element, connected in a rotationally fixed manner to the second element,
characterised in that:
the second planetary gear set (34) has a sixth element, connected in a rotationally fixed manner to the third element, and
a third planetary gear set (54) is provided, which has a seventh element, which is or can be connected in a rotationally fixed manner to the first element, an eighth element, which is or can be connected in a rotationally fixed manner to the first rotor (20) or the second rotor (28), and a ninth element, which is or can be connected in a rotationally fixed manner to the fourth element.

2. Electric drive system (10) according to claim 1,
characterised in that
a first stationary transmission ratio of the first planetary gear set (32) has the same absolute value and an opposing sign in comparison to a second stationary transmission ratio of the second planetary gear set (34).

3. Electric drive system (10) according to claim 2,
characterised in that
the first stationary transmission ratio has a value of −2, the second stationary transmission ratio has a value of +2 and a third stationary transmission ratio of the third planetary gear set has a value of substantially 5/3.

4. Electric drive system (10) according to one of the preceding claims,
characterised in that:
the second element is formed as a first planetary carrier (46) of the first planetary gear set (32) in the form of a single planetary carrier having first planetary gears (62),
the fifth element is formed as a second planetary carrier (50) of the second planetary gear set (34) in the form of a double planetary carrier having second planetary gears (64) and third planetary gears (66), and
the first planetary gears (62) are formed to be separate from the second planetary gears (64) and to be separate from the third planetary gears (66).

5. Electric drive system (10) according to one of the preceding claims,
characterised in that the third element and the sixth element have the same toothing diameter and number of teeth.

6. Electric drive system (10) according to one of the preceding claims,
characterised in that the eighth element is formed as a sum shaft of the third planetary gear set (54).

7. Electric drive system (10) according to one of the preceding claims,
characterised by:
a first switching element (SE1) which is formed to connect the first rotor (20) or the second rotor (28) in a rotationally fixed manner to the eighth element, and
a second switching element (SE2) which is formed to connect the first rotor (20) in a rotationally fixed manner to the first element.

8. Electric drive system (10) according to claim 7,
characterised by:
a third switching element (SE3) which is formed to connect the second rotor (28) in a rotationally fixed manner to the fourth element.

9. Electric drive system (10) according to one of the preceding claims,
characterised in that:
the first element is formed as a first sun gear (44),
the fourth element is formed as a second sun gear (49),
the third element is formed as a first annular gear (48), and
the sixth element is formed as a second annular gear (52).

10. Electric drive system (10) according to one of the preceding claims,
characterised by
a blocking switching element, which is formed to connect two elements of the first planetary gear set (32) and of the second planetary gear set (34), which are not permanently connected to each other in a rotationally fixed manner, to each other in a rotationally fixed manner.

11. Electric drive system (10) according to one of the preceding claims,
characterised in that the three planetary gear sets (32, 34, 54) and the two rotors (20, 28) are all arranged coaxially to each other.
